(19) United States
(12) Patent Application Publication
(10) Pub. No.: US 2009/0129753 A1
(43) Pub. Date: May 21, 2009

(54) DIGITAL PRESENTATION APPARATUS AND METHODS

(76) Inventor: Clayton Wagenlander, Fort Thomas, KY (US)

Correspondence Address: WOOD, HERRON & EVANS, LLP, 2700 CAREW TOWER, 441 VINE STREET, CINCINNATI, OH, 45202, US

(21) Appl. No.: 12/271,215

(22) Filed: Nov. 14, 2008

Related U.S. Application Data
(60) Provisional application No. 60/988,578, filed on Nov. 16, 2007.

(51) Int. Cl. H04N 5/00

(52) U.S. Cl. 386/117; 386/E05.003

(57) ABSTRACT

An apparatus and method is provided for displaying components of a performance. The apparatus includes a computer and a time code generator in communication with the computer and selectively controlled by the computer to generate a time code signal. The system further comprises a digital video recorder with at least one output channel that each have respective video and audio outputs. The digital video recorder is in operable communication with the time code generator and responsive to the time code signal to output at least a portion of a first video component and a corresponding first audio component of the performance synchronized to the time code signal to a respective first video display and first audio amplifier.

### CROSS-REFERENCE TO RELATED APPLICATIONS

This application is related to and claims the benefit of U.S. Provisional Patent Application Ser. No. 60/988,578, entitled “DIGITAL PRESENTATION APPARATUS AND METHODS” and filed on Nov. 16, 2007, which application is incorporated by reference herein.

### FIELD OF THE INVENTION

This invention relates to the recording and display of audio and video components of performances for preferred use in the fields of entertainment and performances.

### BACKGROUND

Modern entertainment events or performances often include a plurality of individual performers, such as musicians, vocalists, and/or other performers, each contributing at least a portion of a video and/or audio component to the overall performance to achieve a desired aesthetic. Modern performances have also often become grand spectacles that often fill large auditoriums with vast amounts of people who typically enjoy the performances of the individual performers and the stagecraft of the multi-component performance. A typical modern performance includes a plurality of vocal and instrumental effects amplified by a plurality of speakers and often additionally involves pyrotechnics, lighting effects, visual displays, and other visual and auditory presentations that are used to compliment the performance and produce a desired aesthetic and entertaining experience.

However, modern performances often fail to transition well to a media. For example, a modern joint performance often includes unique video and audio components by individual performers that are frequently lost or diminished when that overall performance is recorded to a disk and displayed on a typical display system, as there is a limited focus on any individual performer at any particular time. Thus, there is a lack of realism and immersion with a typical display system that occurs when viewing a modern performance that has been translated to a media. Moreover, modern performances are difficult to recreate, as typical systems often mix the audio components of many individual performances to re-create the performance. As such, the audio components of the individual performances may be subject to distortion and suffer variances as they are played through the one set of speakers that is often the only audio output on a typical display system. This distortion, as well as the lack of realism, often results in a less than enthusiastic response to the performance.

Moreover, modern performances are frequently extremely expensive to produce. For instance, modern performances are typically reserved for large areas able to accommodate large quantities of people in order to recoup costs often associated with those modern performances. As such, modern performances are often limited to large venues near large city centers, typically leaving smaller venues lacking and unable to command attention from often desired performers.

Accordingly, it is desirable to provide an apparatus and method to display a performance that is able to more adequately recreate the experience of a modern performance while providing a greater aesthetic than typical display systems.

### SUMMARY OF THE INVENTION

To these ends, embodiments of the invention provide improved apparatuses and methods to record and then display components of a performance. Essentially, in one embodiment of the invention, a time code signal is linked or coupled to recorded video and audio signals for each performance or presenter and their individual contributions to the overall performance may be recorded. These signals and individual performances may be selectively displayed and replayed on individual display devices separately from, but coordinated in time with, the display of other recorded video and audio components, thereby reproducing a joint performance selectively and with the full fidelity and effect as if in real time. The aesthetic and entertainment values of the invention are both widely varied and enormous. For example, individual video and audio components of individual performances of a coordinated performance are separately recorded, aligned with a common time code signal, and selectively displayed to produce a desired aesthetic, entertaining performance of any or all of the components in video, audio, or combinations thereof. At least a portion of the individual video and audio components of the individual performances may be then synchronized and selectively displayed along with additional performances and/or presentations, such as live performances, images, text, video, multimedia presentations, or combinations thereof. Moreover, these individual video and audio components may be further synchronized with effects, such as lighting and/or atmospheric effects from spotlights, fog machines, laser projectors, and other accessories.

Even more particular, and in more detail, an apparatus for displaying components of a performance includes a computer and a time code generator in communication with the computer and selectively controlled by the computer to generate a time code signal. The apparatus further includes a digital video recorder having at least one output channel. Each output channel includes a respective video and audio output. The digital video recorder is in communication with the time code generator and responsive to the time code signal to output at least a portion of a first video component and a corresponding first audio component of the performance synchronized to the time code signal to a respective first video display and first audio amplifier. The digital video recorder may include at least two output channels, and the digital video recorder may be further responsive to the time code signal to output at least a portion of a second video component and a corresponding second audio component of the performance synchronized to the time code signal to a respective second video display and second audio amplifier.

The apparatus may include at least one accessory in communication with the computer and selectively controlled by the computer to produce at least one of a lighting effect or an atmospheric effect based on the time code signal. The at least one accessory includes a spotlight, a fog machine, a laser projector, and combinations thereof. Moreover, the digital video recorder may be a first digital video recorder and the apparatus may include a second digital video recorder. The second digital video recorder may also have at least one output channel, with each channel having respective video and audio outputs. The second digital video recorder may also be in communication with the time code generator and responsive to the time code signal to output at least one of text, an image, a video, or a multi-media presentation synchronized to the performance on a second video display.

The apparatus may also include a microphone having an audio output and an audio mixer in communication with the digital video recorder and the microphone. Thus, the audio mixer may receive the first audio component from the digital video recorder and receive the audio output from the microphone, and be operable to play the first audio component of the performance on the first audio amplifier and play the audio output of the microphone on a second audio amplifier. The apparatus may also include a video camera having a video output and a video mixer in communication with the digital video recorder and the video camera. Thus, the video mixer may receive the first video component from the digital video recorder and receive the video output from the video camera, and the video mixer may be operable to display the first video component of the performance on the first video display and display the video output on a second video display.

In some embodiments, the apparatus may include at least one audio mixer in communication with the digital video recorder and an external audio source. The audio mixer may be operable to receive the first audio component from the digital video recorder and the audio mixer may be operable to receive a second audio component from the external audio source. Thus, the audio mixer may be further operable to play the first audio component of the performance on the first audio amplifier and play the second audio component on a second audio amplifier. Similarly, the apparatus may include at least one video mixer in communication with the digital video recorder and an external video source. The video mixer may be operable to receive the first video component from the digital video recorder and the video mixer may be operable to receive a second video component from the external video source. Thus, the video mixer may be further operable to display the first video component of the performance on the first video display and display the second video component on a second video display. The external video source may be an external video source selected from the group consisting of a video camera, a second digital video recorder, the computer, a second computer, or combinations thereof.

In some embodiments, the apparatus may include at least one microphone in communication with the digital video recorder and at least one video camera in communication with the digital video recorder. As such, the digital video recorder may be configured to record the first audio component of the performance with the at least one microphone and record the first video component of the performance with the at least one video camera. Additionally, the digital video recorder may be configured to associate the first audio component and the first video component with the time code signal from the time code generator at the time of recording.

In another embodiment, an apparatus for displaying components of a performance is provided that includes a time code generator for generating a time code signal and a digital video recorder having at least one output channel. Each output channel may have a respective video and audio output. The digital video recorder may be in communication with the time code generator, and the digital video recorder may be responsive to the time code signal to output at least a portion of a first video component and a corresponding first audio component of the performance synchronized to the time code signal on a first output channel. In that embodiment, the apparatus further includes a first computer in communication with the time code generator and the digital video recorder, and configured to selectively control the time code generator to generate the time code signal. The first computer may be configured to receive the synchronized video and audio components of the performance and provide the synchronized video and audio components of the performance to a second computer for displaying the video component on a respective video display and for playing the audio component on a respective audio amplifier.

In some embodiments, a method of recording and displaying a performance with an apparatus is provided that includes the steps of aligning recorded components of the performance with a time code signal and selectively displaying at least a portion of a first video component of the performance and selectively playing at least a portion of a first audio component of the performance corresponding to the first video component based on the time code signal. The method may include simultaneously displaying at least a portion of a second video component and selectively playing at least a portion of a second audio component of the performance corresponding to the second video component based on the time code signal. The method may further include aligning commands for at least one accessory with the time code signal and selectively controlling the at least one accessory to produce at least one of a lighting effect or an atmospheric effect based on the time code signal.

In some embodiments, the method further includes aligning at least one of text, an image, a video, or a multi-media presentation with the time code signal and displaying the at least one of a selection of text, an image, a video, or a multi-media presentation based on the time code signal. Moreover, the method may include selectively amplifying at least one audio output of a microphone of a live performer. In some embodiments, the method further includes separately recording the audio and video components of a plurality of individual performers of the performance and associating each separate recording of the audio and video components of the plurality of individual performers with the time code signal. In that embodiment, the method may further includes selectively controlling the display of the first video component and the playing of the first audio component corresponding to the first video component to cease the display of at least one of the first video component and the first audio component. Moreover, the method may include selecting a performance to display and determining a time code signal associated with that performance and with which to align the recorded components of the performance.

Accordingly, the advantages of the invention and its various embodiments are numerous. For example, embodiments of the invention may be used to synchronize and selectively display video and/or audio components of at least a portion of individual performances of a coordinated performance and act as a virtual band from which coordinated performances may be selectively chosen, act as a virtual backup band for live vocalists, selectively display additional text and act as a virtual backup band for karaoke, selectively display commercial messages with the coordinated performance, and/or integrate additional effects, images, text, video, multimedia presentations, or combinations thereof into a coordinated performance. As such, embodiments of the invention may be configured to create the entertaining and aesthetic experience of a live performance without the issues associated with live performances. Moreover, embodiments of the invention may be used to selectively display video and/or audio components of a least a portion of individual performances of a coordinated performance that is not a musical performance. For example, embodiments of the invention may be used to selectively display video and/or audio components of a presentation by one or more persons, a dramatic performance by one or more persons, and/or embodiments of the invention may be used to simultaneously tape a coordinated performance at a first location and display that coordinated performance live at a second location. Thus, embodiments of the invention may be used to synchronize and selectively display at least a portion of a recorded coordinated performance, display at least a portion of a live coordinated performance, interact with live performances, incorporate branding with coordinated performances, and/or display at least a portion of a dramatic performance or presentation.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is a diagrammatic illustration of one embodiment of an arrangement of a multi-component performance in which the audio and video components of the individual performances may be separately and independently recorded consistent with embodiments of the invention;

FIG. 2 is a diagrammatic illustration of an alternative embodiment of an arrangement of a multi-component performance consistent with alternative embodiments of the invention in which the audio and video components of the individual performances may be separately recorded consistent with embodiments of the invention;

FIG. 3 is a flowchart illustrating one process of recording the video and audio components of individual performances of the multi-component performance arrangement 10 illustrated in FIG. 1;

FIG. 4 is a flowchart illustrating one process of recording the video and audio components of individual performances of the multi-component performance arrangement 30 illustrated in FIG. 2;

FIG. 5 is a perspective illustration of a set that may display synchronized audio and video components of individual performances of a multi-component performance consistent with embodiments of the invention;

FIG. 6 is a diagrammatic illustration of one embodiment of a control system to display a multi-component performance on the set of FIG. 5;

FIG. 7 is a diagrammatic illustration of an alternative embodiment of a control system to display a multi-component performance on the set of FIG. 5;

FIG. 8 is a diagrammatic illustration of another alternative embodiment of a control system to display a multi-component performance on the set of FIG. 5;

FIG. 9 is a flowchart illustrating a process for at least one of the systems of FIGS. 6-8 to display a multi-component performance on the set of FIG. 5; and

FIG. 10 is a flowchart illustrating a process for program code that may be executed by one of the systems of FIGS. 6-8 to select a multi-component performance consistent with embodiments of the invention.

It should be understood that the appended drawings are not necessarily to scale, presenting a somewhat simplified representation of various preferred features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments may have been enlarged or distorted relative to others to facilitate visualization and clear understanding.

### DETAILED DESCRIPTION

Embodiments of the invention include an apparatus and methods to record and display audio and visual performances. In some embodiments, individual video and audio components of a coordinated performance are independently recorded, aligned with a common time code signal (e.g., such as an “SMPTE” time code signal), and selectively displayed to produce a desired aesthetic, entertaining performance of any or all of the components in video, audio, or combinations thereof. In an alternative embodiment, individual video and audio components of a coordinated performance are recorded at the same time, isolated from each other, aligned with a common time code signal, and selectively displayed to produce a desired aesthetic, entertaining performance of any or all of the components in video, audio, or combinations thereof. Throughout the embodiments, the individual video and audio components of the coordinated performances may be selectively displayed with additional performances and/or presentations, such as live performances, images, text, video, multimedia presentations, or combinations thereof. Moreover, throughout the embodiments, the video and audio components, as well as the additional performances and/or presentations, may be broadcast over a network and displayed at a geographically distant location.

### Multi-Component Performance Recording Arrangements

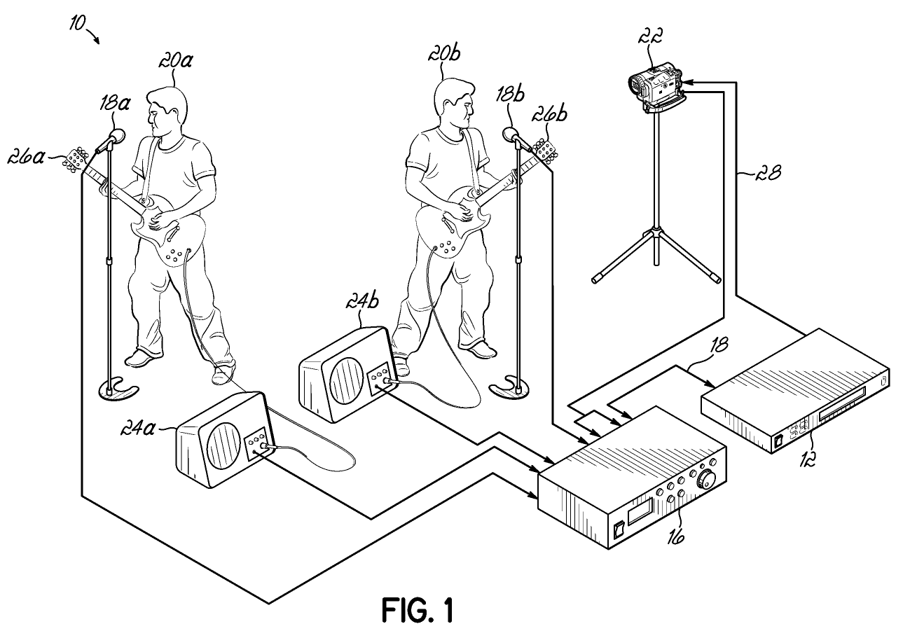

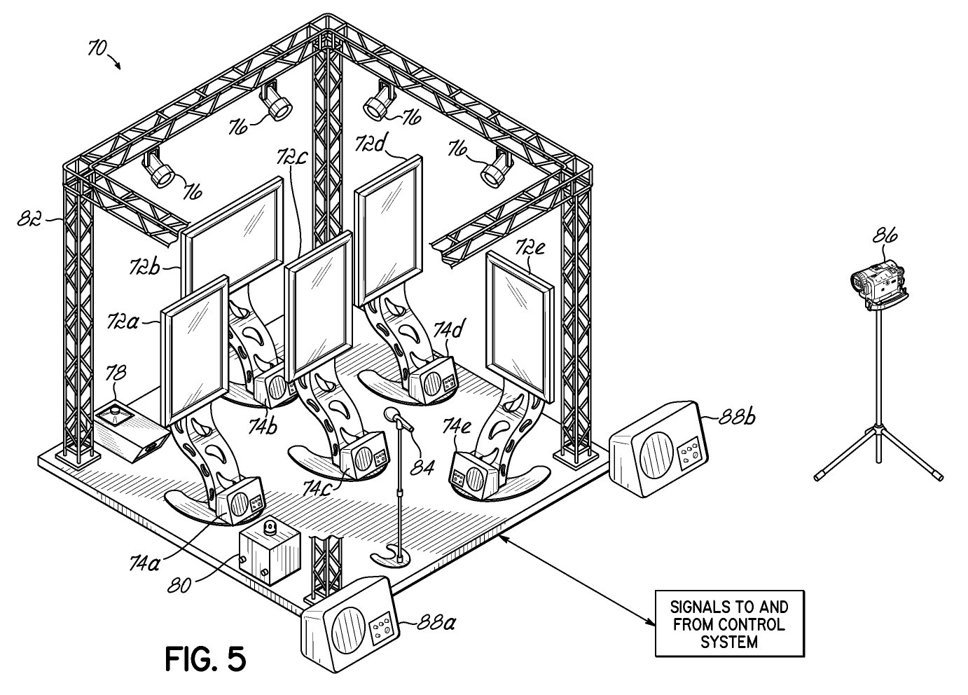

Turning to the drawings, wherein like numbers denote like parts throughout the several views, FIG. 1 is a diagrammatic illustration of one embodiment of an arrangement 10 of a multi-component performance in which the audio and video components of the individual performances may be separately and independently recorded consistent with embodiments of the invention. The coordinated performance may be a multi-part (e.g., a multi-part performance that includes a plurality of individual performances by a corresponding plurality of performers) and multi-component (e.g., a multi-component performance that includes at least two components, such as a video component and an audio component) performance (e.g., hereinafter, a “multi-component performance”). The arrangement 10 may include at least one time code generator 12 to generate a time code signal 14 for at least one digital video recorder, or digital audio/video deck 56 (illustrated as, and hereinafter, “A/V Deck” 56). As illustrated in FIG. 5, the arrangement 10 includes one microphone 18a, 18b to record the vocal performances of each performer 20a, 20b, respectively, and a video camera 86 to record the video performance of the arrangement 10 as a whole. The arrangement 10 may further include at least one audio amplifier 24a, 24b for each performer 20a, 20b to amplify an instrument 26a, 26b of the performer 20a, 20b, respectively. As illustrated, each performer 20a, 20b is playing a powered instrument 26a, 26b, which in specific embodiments may be guitars. When the instrument is not a powered instrument 26a, 26b, the arrangement 10 may be configured with an additional microphones (not shown) for the performer's 20a, 20b non-powered instrument, and/or the microphone 18a, 18b for the respective performer 20a, 20b may be configured to record the sound from that non-powered instrument.

As illustrated in FIG. 1, the time code generator 12 is configured to supply a time code signal as at 28 to the video camera 86 and provide the time code signal 14 to the A/V deck 16. The A/V deck 16, in turn, may be configured to record the video and audio components of at least two separate individual performances of the respective performers 20a, 20b during a multi-component performance. Thus, the video component of the multi-component performance from the camera 22 is configured to be recorded by the A/V deck 16 as well as associated with a time code signal, the audio component of the first performer 20a from the microphone 18a and/or the amplifier 24a is configured to be recorded by the A/V deck 16 as well as associated with a time code signal, and the audio component of the second performer 20b from the microphone 18b and/or amplifier 24b is configured to be recorded by the A/V deck 16 as well as associated with a time code signal. In some embodiments, the video component of the multi-component performance as recorded by the video camera 86 may be duplicated and recorded as the video component for the individual performances of the performers 20a, 20b. As such, the individual performances of the multi-component performance, each of which includes an audio component and a video component, may be associated with a time code and stored in the A/V deck 16.

To record separate video components of a multi-component performance, each performer 20a, 20b may have the audio and video components of their individual performance separately recorded and synchronized with the time code signal associated with the original performance. For example, a multi-component performance with two or more performers may be recorded. Subsequently, each performer may have their individual audio and video components of the multi-component performance re-recorded and synchronized with the time code signal of the original multi-component performance. In specific embodiments, each performer may perform their individual performance and be recorded while the original multi-component performance is played, as well as have their individual performances associated with the same time signal as the multi-component performance. That process may be repeated for each performer.

As illustrated in FIG. 1, the arrangement 10 includes at least one time code generator 12, one A/V deck 16, two microphones 18a, 18b, two performers 20a, 20b, two amplifiers 24a, 24b, and one video camera 86. One having ordinary skill in the art will appreciate that more or fewer time code generators 12, A/V decks 16, microphones 18a, 18b, performers 20a, 20b, amplifiers 24a, 24b, and video cameras 22 may be included without departing from the scope of the invention. For example, the arrangement 10 could include more performers and have one A/V deck 16 configured to record the audio and video components of individual performances of the multi-component performance for every two performers. In specific examples, the arrangement 10 may include four performers and use two A/V decks 16 to each record two individual performances of the multi-component performance. Moreover, the arrangement 10 may include additional components without departing from the scope of the invention. For example, the arrangement 10 may include one or more audio mixers to mix the audio from the performers 20a, 20b, one or more video mixers to replicate the video component recorded by the video camera 86, and/or other components well known in the art. Additionally, the arrangement 10 may include one or more video monitors to view the multi-component performance as it is recorded.

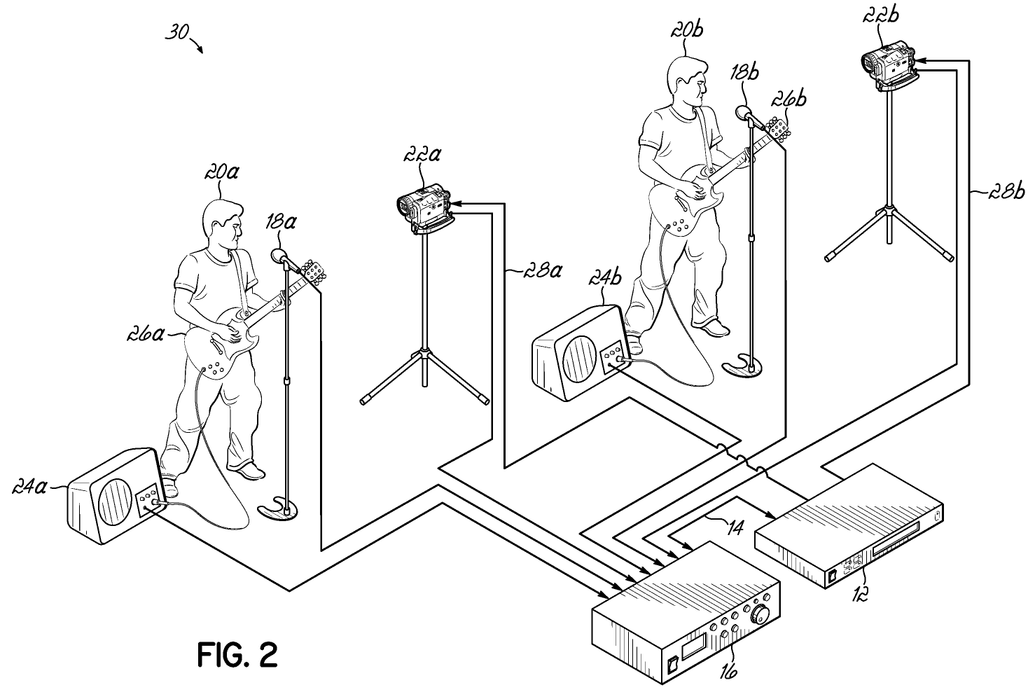

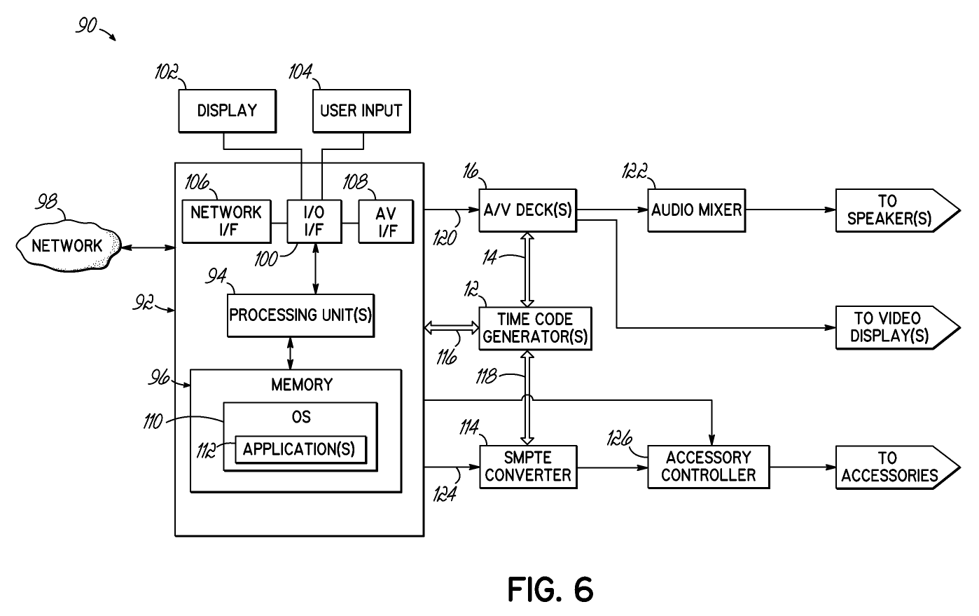

FIG. 2 is a diagrammatic illustration of an alternative embodiment of an arrangement 30 of a multi-component performance in which the audio and video components of the individual performances may be separately recorded consistent with alternative embodiments of the invention. The arrangement 30 may include at least one time code generator 12 to generate a time code signal 14 for at least one A/V deck 16 to record at least one individual performance of the multi-component performance. As illustrated in FIG. 2, the arrangement 30 includes one microphone 18a, 18b to record the vocal performance of each performer 20a, 20b, respectively, and one video camera 86a, 22b to record the video performance of each performer 20a, 20b, respectively. As such, the arrangement 30 of FIG. 6 may be configured to record the video component of each individual performance of a multi-component performance separately and at the same time, as opposed to the arrangement 10 of FIG. 1 which requires that the video component of each individual performance of a multi-component performance be recorded separately and independently. As such, the arrangement 30 of FIG. 2 advantageously results in less time being required to record each video component of each individual performance of the multi-component performance at a later time. Similarly to the arrangement 10 of FIG. 1, the arrangement 30 of FIG. 2 may further include at least one amplifier 24a, 24b and at least one powered instrument 26a, 26b.

In a similar manner as in the arrangement 10 of FIG. 1, the arrangement 30 of FIG. 2 includes the time code generator 12 to supply a time code signal to the video cameras 22a, 22b as at time code signals 28a and 28b, respectively, as well as supply the time code signal 14 to the A/V deck 16. Thus, the video component of the first performer 20a from the video camera 86a is configured to be recorded by the A/V deck 16 as well as associated with a time code signal, the audio component of the first performer 20a from the microphone 18a and/or audio amplifier 24a is configured to be recorded by the A/V deck 16 as well as associated with a time code signal, the video component of the second performer 20b from the camera 22b is configured to be recorded by the A/V deck 16 as well as associated with a time code signal, and the audio component of the second performer 14b from the microphone 18b and/or audio amplifier 24b is configured to be recorded by the A/V deck 16 as well as associated with a time code signal. As such, the arrangement 30 of FIG. 2 illustrates that the video and audio components of the individual performances of a multi-component performance are recorded separately and at the same time as the performance of the multi-component performance.

As illustrated in FIG. 2, the arrangement 30 includes one time code generator 12, one A/V deck 16, two microphones 18a, 18b, two performers 20a, 20b, two amplifiers 24a, 24b, and two video cameras 22a, 22b. One having ordinary skill in the art will appreciate that more or fewer time code generators 12, A/V decks 16, microphones 18a, 18b, performers 20a, 20b, amplifiers 24a, 24b, and video cameras 22a, 22b may be included without departing from the scope of the invention. For example, the arrangement 30 could include more performers and have one A/V deck 16 configured to record the audio and video components of individual performances of the multi-component performance for every two performers. In specific examples, the arrangement 30 may include four performers and use two A/V decks 16 to each record two individual performances of the multi-component performance. Moreover, the arrangement 30 may include additional components without departing from the scope of the invention. For example, the arrangement 30 may include one or more audio mixers to mix the audio from the performers 20a, 20b, one or more video mixers to the video components recorded by the video cameras 22a, 22b, and/or other components well known in the art. Additionally, the arrangement 30 may include one or more video monitors to view the video components of the multi-component performance as it is recorded.

### Recording Multi-Component Performances

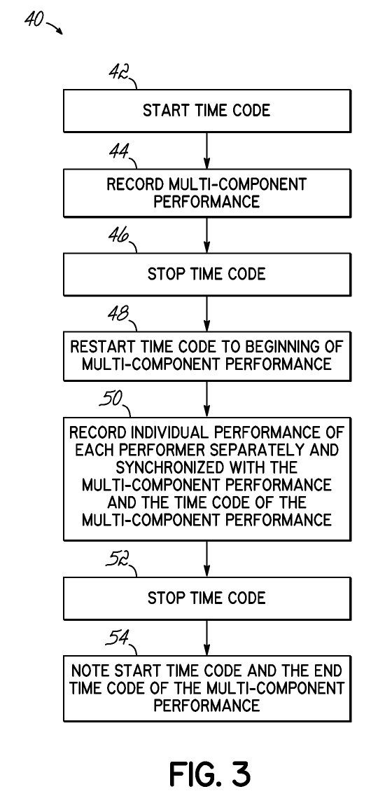

FIG. 3 is a flowchart 40 illustrating one process of recording the video and audio components of individual performances of the multi-component performance arrangement 10 illustrated in FIG. 1 consistent with embodiments of the invention. Referring back to FIG. 3, to record the multi-component performance, the time code is started (block 42) and the multi-component performance of a plurality of performers is associated with the time code and recorded with at least one video camera (block 44). In some embodiments, the multi-component performance may be recorded on at least on A/V deck, and in specific embodiments a plurality of A/V decks are configured to record at least one audio component of at least one individual performer as well as the video component of the multi-component performance. In further specific embodiments, each A/V deck is configured to record the audio component of two individual performers from among a plurality of performers as well as the video component of the multi-component performance. Once the multi-component performance has completed, the time code and recording is stopped (block 46).

In order to record a plurality of individual performances of the multi-component performance arrangement 10 such as that illustrated in FIG. 1 and play those individual performances in a synchronized manner, the individual performances of the multi-component performance must be recorded separately and independently. To record the individual performances, the time code is restarted to the beginning of the multi-component performance for each performer (block 48) and the individual performance of each performer is recorded separately and synchronized with the multi-component performance as well as the time code of the multi-component performance (block 50). In some embodiments, the multi-component performance may be played to each individual performer while the audio and video components of their individual performances are recorded, thus allowing the individual performers to synchronize their individual performances to the multi-component performance and thus the time code of the multi-component performance. For example, a performer may be instructed to synchronize their actions to the original multi-component performance, the multi-component performance may be played to each individual performer with a first A/V deck, and the audio and video components of the individual performance of that performer may be recorded on that first A/V deck or a separate second A/V deck and associated with the same time code as the multi-component performance. In specific embodiments, two individual performances of a multi-component performance are recorded on each A/V deck. As such, one of ordinary skill in the art will appreciate that blocks 48 and 50 may be repeated for each performer of a multi-component performance until all the individual performances of the multi-component performance have been recorded.

After recording an individual performance, the time code may be stopped (block 52) and the start time code of the multi-component performance (and thus the start time code of the individual performances of the multi-component performance), as well as the end time code of the multi-component performance (and thus the end time code of the individual performances of the multi-component performance) may be noted and stored (block 54). Thus, flowchart 40 of FIG. 3 illustrates a process to record an initial multi-component performance, then separately and independently record audio and video components of the individual performances of the multi-component performance.

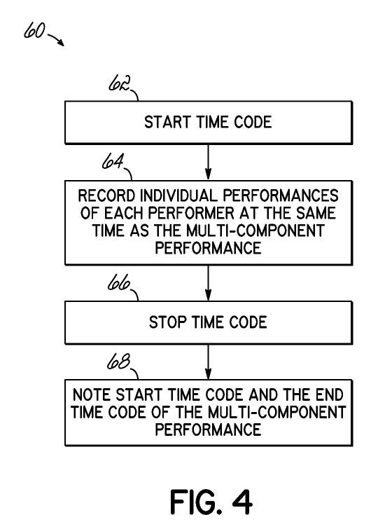

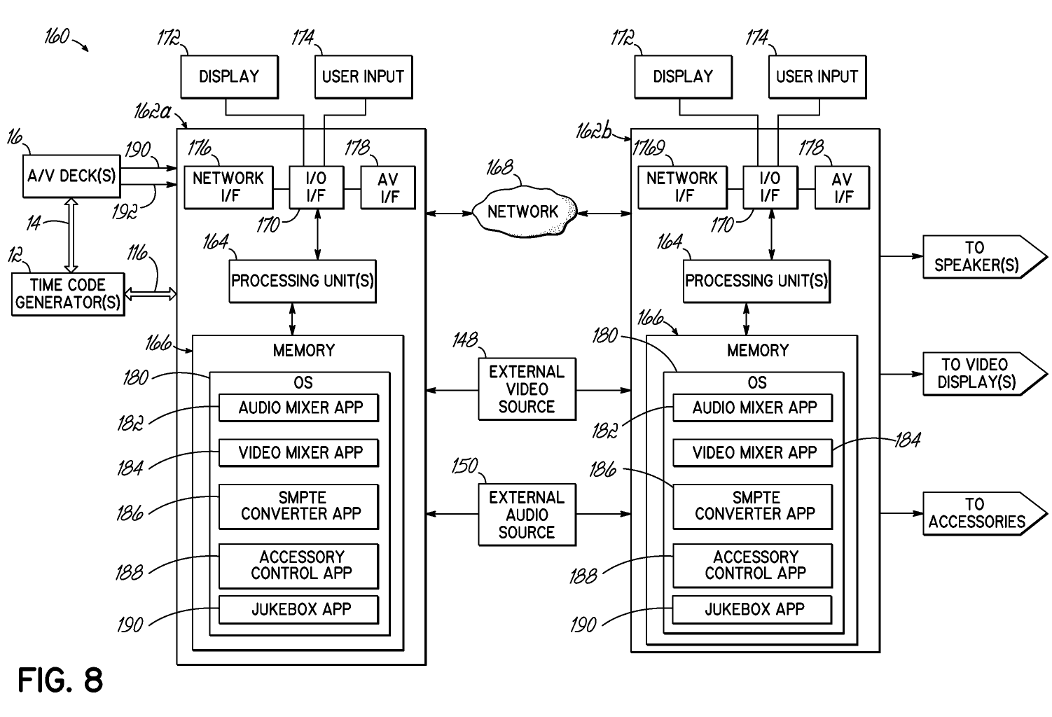

FIG. 4 is a flowchart 60 illustrating one process of recording the video and audio components of individual performances of the multi-component performance arrangement 30 such as that illustrated in FIG. 2 consistent with embodiments of the invention. Referring back to FIG. 3, to record the multi-component performance, the time code is started (block 62), the multi-component performance of a plurality of performers is associated with the time code, and each of the individual performances of the multi-component performance is separately recorded at the same time (block 64). In some embodiments, an A/V deck is configured to record the audio and video component of at least one individual performance, and in specific embodiments an A/V deck is configured to record the audio and video components of at least two individual performances. Once the multi-component performance has completed, the time code and recording is stopped (block 66) and the start time code of the multi-component performance (and thus the start time code of the individual performances of the multi-component performance), as well as the end time code of the multi-component performance (and thus the end time code of the individual performances of the multi-component performance), may be noted and stored (block 68). Thus, flowchart 60 of FIG. 8 illustrates a process to record the audio and video components of the individual performances of a multi-component performance at the same time, advantageously avoiding iterative recording of the individual performances separately and independently.

### Set to Perform Multi-Component Performances

In some embodiments, a multi-component performance may be stored on at least one A/V deck 16 in communication with at least one time code generator 12. In specific embodiments, the audio and video components of two individual performances of a multi-component performance may be stored on respective channels for each A/V deck 16. Thus, for example, a multi-component performance with two performers may be stored on one A/V deck 16, a multi-component performance with three performers may be stored on two A/V decks 16, and a multi-component performance with 255 performers may be stored on 128 A/V decks 16. In specific embodiments, each channel of an A/V deck 16 is configured such that the individual performances on that A/V deck 16 are stored sequentially and associated with a time code signal. For example, and with reference to a first channel of the A/V deck 16, an individual performance of a first multi-component performance stored on an A/V deck 16 may be stored at the beginning of the storage of the A/V deck 16 and associated with a time code signal, the beginning of which may read 01:00:00:00, and an individual performance of a second multi-component performance stored on that A/V deck 16 may be stored sequentially after the individual performance of the first multi-component performance and associated with a time code signal, the beginning of which may read 02:00:00:00, thus indicating that the individual performance of the second multi-component performance is a second scene and not associated with the individual performance of the first multi-component performance. Additionally, a second individual performance of the first multi-component performance may be stored on the second channel of the A/V deck 16 at the beginning of the storage of the A/V deck and also associated with a time code signal, the beginning of which may also read 01:00:00:00. Thus, the A/V deck 16 may selectively display both the audio and video components of both individual performances to recreate at least a portion of the multi-component performance when the time code signal from the time code generator 12 indicates the time code associated with that multi-component performance. Thus, for an apparatus consistent with embodiments of the invention to play a multi-component performance, the apparatus may control a time code generator 12 to queue at least one A/V deck 16 to the time code signal associated with that multi-component performance, then display synchronized audio and video components of individual performances of that multi-component performance on a set consistent with embodiments of the invention along with synchronized lighting and/or atmospheric effects.

FIG. 5 is a perspective illustration of a set 70 that may display synchronized audio and video components of individual performances of a multi-component performance consistent with embodiments of the invention. The set 70 may include a plurality of video displays 72a-d and a corresponding plurality of audio amplifiers 74a-d, or “speakers” 74a-d. In various embodiments, each video display 72a-d may be a plasma display panel, a liquid crystal display, an organic light emitting diode display, a digital light processing display, a cathode ray television, and/or another display, such as a video projection system. Each video display 72a-d may be selectively controlled to display an individual video component of a multi-component performance, while each speaker 74a-d may be associated with a respective video display 72a-d and selectively controlled to play an individual audio component of a multi-component performance associated with that individual video component. As such, and as illustrated in FIG. 5, the set 70 may include a plurality of video displays 72a-d each associated with a respective at least one speaker 74a-d to singly, or in combination, selectively perform individual video and audio components of a multi-component performance.

In some embodiments, the video displays 72a-d may be identical and the speakers 74a-d may be identical. In alternative embodiments, the video displays 72a-d may include at least one video display that is a different size than the rest, such as video display 72b. Similarly, the video displays 72a-d may include at least one video display that is in a different orientation than the rest, such as video display 72a-d. Moreover, the speakers 74a-d may not be identical, and in a specific alternative embodiment at least one of the speakers 74a-d may be a speaker designed for a specific function, such as a bass guitar audio amplifier. As such, at least one of the video displays 72a-d and at least one of the speakers 74a-d may be configured to selectively display a particular individual performance of the multi-component performance.

In addition to the plurality of video displays 72a-d associated with a corresponding plurality of speakers 74a-d for performing individual video and audio components of the multi-component performance, the set may include at least one additional video display 72e and at least one additional speaker 74e. In some embodiments, the additional video display 72e and/or speaker 74e is selectively controlled to display an additional live performance, an additional pre-recorded performance, text, an image, a video, a multimedia presentation, or combinations thereof. Thus, and in one example, the set 70 may be a karaoke set and selectively controlled to perform individual video and audio components of a multi-component performance on the video displays 72a-d and corresponding speakers 74a-d, as well as display text on video display 72e and utilize speaker 74e as an audio monitor for a performer. Alternatively, and in another example, video display 72e may be configured display to another part of the multi-component performance, advertisements, an image, text, a video, a multimedia presentation, or combinations thereof. In that alternative example, the speaker 74e may also be configured to play a performance unrelated to the video component of a multi-component performance displayed by the video display 72e or the other video displays 72a-d of the set 70, or the speaker 74e may be selectively controlled to play audio associated with the part of the multi-component performance displayed by the video display 72e or the other video displays 72a-d of the set 70.

One or more of the speakers 74a-e may be configured with at least one pre-amplifier (not shown). The preamplifier may be configured to amplify the level of signals (e.g., the power levels, voltage levels, and/or current levels) to the speakers 74a-e to bring those signals to line-level signals as is well known in the art.

In addition to the video displays 72a-e and the speakers 74a-e, the set 70 may be configured with at least one accessory, such as a spotlight 76, a fog machine 78, a laser projector 80, and/or another accessory as is well known in the art. In some embodiments, the spotlight 76, fog machine 78, laser projector 80, and/or another accessory (collectively, the “accessories 76, 78, 80”) are configured to be controlled through a communications protocol, such as the DMX512-A communications protocol (“DMX”) and/or the musical instrument digital interface communications protocol (“MIDI”), as may be appropriate to control lighting and atmospheric effects. As such, each of the accessories 76, 78, 80 may be controlled through DMX and/or MIDI and aligned with the multi-component performance to achieve a desired aesthetic, entertaining performance in conjunction with the multi-component performance. At least one of the accessories 76, 78, 80 may be mounted on a superstructure 82 of the set 70. The superstructure 82 may be a frame comprising various lengths and thicknesses of supports as is well known in the art.

As illustrated in FIG. 5, a microphone 84 and a video camera 86 may be positioned proximate the set 70, or even among the video displays 72a-e and speakers 74a-e of the set 70, for integration of a live performance with multi-component performance. For example, the audio signal from the microphone 84 may be played on the at least one of the speakers 74a-e as a monitor for a performer at the speaker, and/or the audio signal from the microphone 84 may be played on at least one of the speakers 74a-e for an audience. Moreover, the video signal from the video camera 86 may be displayed on at least one of the video displays 72a-e for an audience. Also as illustrated, the set 70 may include at least one additional set of speakers 88a, 88b that may be configured as public announcement speakers, that may be configured to play the sound recorded by the microphone 84 rather than at least one of the speakers 74a-e, or that may be configured to operate in conjunction with at least one of the speakers 74a-e.

### Apparatuses to Perform Multi-Component Performances

FIG. 6 is a diagrammatic illustration of one embodiment of a control system 90 (“system” 30) to display a multi-component performance on the set 70 of FIG. 5. As illustrated in FIG. 6, the system 90 may include at least one computing system 92 that typically includes at least one processing unit 94 communicating with a memory 96. The processing unit 94 may be one or more microprocessors, micro-controllers, field-programmable gate arrays, or ASICs, while memory 96 may include random access memory (“RAM”), dynamic random access memory (“DRAM”), static random access memory (“SRAM”), flash memory, and/or another digital storage medium. As such, memory 96 may be considered to include memory storage physically located elsewhere in the computing system 92, e.g., any cache memory in the at least one processing unit 94, as well as any storage capacity used as a virtual memory, e.g., as stored on a mass storage device, a computer, or another controller coupled to the computing system 92 by way of a network 98. In specific embodiments, the computing system 92 may be a computer (e.g., a desktop or laptop computer), computer system, video server, media server, controller, server, disk array, or programmable device such as a multi-user computer, a single-user computer, a handheld device, a networked device, or other programmable electronic device. As such, the computing system 92 may include an I/O interface 100 (illustrated as, and hereinafter, “I/O I/F” 100) in communication with a display 102 and at least one user input device 104 to display information to a user and receive information from the user, respectively. In some embodiments, the user input device 104 may include a keyboard, a mouse, a touchpad, and/or other user interface as is well known in the art. In specific embodiments, the display 102 may be configured with the user input device 104 as a touchscreen (not shown). The I/O I/F 100 may be further in communication with a network interface 106 (illustrated as “Network I/F” 106) that is in turn in communication with the network 98. Moreover, the I/O I/F 100 may be further in communication with an audio/video interface 108 (illustrated as “A/V I/F” 108) that is in turn in communication with at least one component of the set 70 and/or the system 90. The computing system 92 may also include an operating system 110 to run program code 112 (illustrated as “Application” 112) to control at least one component of the set 70 and/or the system 90.

In general, and as previously disclosed, when a multi-component performance is recorded, individual video and audio components of each individual performance of the multi-component performance are recorded. Thus, each performer, or a group of performers, of a multi-component performance may have the visual and audio components of their individual performances separately recorded. For example, a drummer of a band performing a portion of a multi-component performance may have their visual and audio components of their individual performance separately recorded from the remaining performers. Also for example, a group of backup singers for a band may have their visual and audio components of their individual performance separately recorded from the remaining performers. However, to reproduce at least a portion of the multi-component performance, the individual video and audio components of a plurality of individual performances must be synchronized, or otherwise aligned. As such, and throughout the embodiments of the invention, the video and audio components of at least some of the individual performances of a multi-component performance may be associated with a time code signal such that, upon playback, selected components of selected performances of the multi-component performance may be displayed based on that time code signal to reproduce at least a portion of the multi-component performance. Thus, the system 90 may include at least one time code generator 12 operable to provide a time code signal to at least one component of the system 90, including the computing system 92, at least one A/V Deck 16, and/or at least one SMPTE to DMX and/or MIDI converter 114 (illustrated as, and hereinafter, “SMPTE converter” 114). As illustrated in FIG. 5, the time code signal is provided to the computing system 92 as at 116, the A/V deck 16 as at 14, and the SMPTE converter 114 as at 118. In some embodiments, the time code generator 12 is configured to generate a SMPTE time code signal, and in specific embodiments the time code generator 12 is an F22 SMPTE time code generator as distributed by Fast Forward Video, Inc. (“FFV”), of Irvine, Calif.

The A/V deck 16 may be a digital video recorder configured to record and replay at least one video and at least one audio component of at least one individual performance of a multi-component performance and associate those components with the time code signal 14 from the time code generator 12. Advantageously, the A/V deck 16 may be configured to record and replay components of at least one individual performance based on the time code signal 14 from the time code generator 12. Thus, as the components of the individual performance are recorded by the A/V deck 16, the time code generator 12 may provide the A/V deck 16 with the time code signal and the A/V deck 16 may store the components on available space and associate those components with the time code signal from the time code generator 12. As such, the A/V deck 16 may be configured to play the components of the individual performance of the multi-component performance in response to the time code signal. In some embodiments, the time code signal associated with a multi-component performance may be supplied by the computing system 92 by the signal line as at 120, or the computing system 92 may control the time code generator 12 to set the time code signal for the multi-component performance in the time code generator 12. For example, the application 112 may be configured with a mapping of time code signals to multi-component performances. When a user selects a multi-component performance, the application 112 may determine the time code signal of the multi-component performance, and thus the time code signal for the individual performances of the multi-component performance, and set the time code generator 12 appropriately. In some embodiments, the A/V deck 16 is a “dual deck” digital video recorder configured to record at least one video component and at least one audio component of two individual performances and replay the components of the two individual performances on independent output channels, each output channel having respective video and audio outputs. In specific embodiments, each A/V deck 16 may be a dual deck DigiDeck Digital Video Recorder as also distributed by FFV.

The at least one A/V deck 16 may be in communication with at least one of the video displays 72a-e of the set 70 such that at least one video component of at least one individual performance of the multi-component performance may be played on that at least one video displays 72a-e. Similarly, the at least one A/V deck 16 may be in communication with at least one speaker 74a-e and/or 88a, 88b through at least one audio mixer 122 such that at least one audio component of at least one individual performance of the multi-component performance may be played on that at least one speaker 74a-e and/or 88a, 88b. The audio mixer 122 may be configured to combine, route, and/or change the level, timber, and/or dynamics of a plurality of audio components, including the audio components of the individual performances of a multi-component performance provided by A/V decks 16. In some embodiments, the audio mixer 122 is a sixteen-channel audio mixer, and in specific embodiments the audio mixer 122 is a Mackie model no. 404-VLZ PRO audio mixer as distributed by LOUD Technologies, Inc., of Woodinville, Wash. The audio mixer 122 may be connected to at least one of the speakers 74a-e and/or 88a, 88b of the set 70 to play at least one audio component of at least one individual performance of a multi-component performance. Furthermore, the audio mixer 122 may be in communication with the time code generator 12 to receive the time code and/or the at least one SMPTE converter 114 to receive a converted time code.

The SMPTE converter 114 may be in communication with the time code generator 12 to receive a time code signal 118 and/or the SMPTE converter 114 may be in communication with the computing system 92 as at signal line 124. In some embodiments, the SMPTE converter 114 is configured to convert the SMPTE time code from the time code generator 12 into a DMX time code and/or a MIDI time code, and/or convert commands from the computing system 92 into a DMX commands and/or MIDI commands for at least one accessory controller 126 to control the accessories 76, 78, 80. Thus, the at least one accessory controller 126 may be controlled by the computing system 92 to manipulate the accessories 76, 78, 80 based on the time code signal from the time code generator 12. For example, the computing system 92 may upload commands to the accessory controller 126 to be executed at specific times. Thus, the accessory controller 126 may execute those commands when the time code signal indicates that a specific time has been reached. Alternatively, the accessory controller 126 may be controlled by the computing system to manipulate the accessories 76, 78, 80 based on the time code signal the computing system 92 receives from the time code generator 12. For example, the application 112 may be responsive to the time code signal 116 from the time code generator 12 to move or otherwise change the spotlight 76, produce fog with the fog machine 78, and/or produce an aesthetic effect with the laser projector 80. In specific embodiments, the at least one accessory controller 126 may be configured to support accessories 76, 78, 80 that communicate by way of DMX and/or MIDI commands, and the accessory controller 126 may be a Blue Light XL lighting controller. Additionally, and in further specific embodiments, the accessory controller 126 may be in communication with the audio mixer 122 and configured to control the audio mixer though MIDI commands that may be received in a similar manner as DMX commands from the computing system 92.

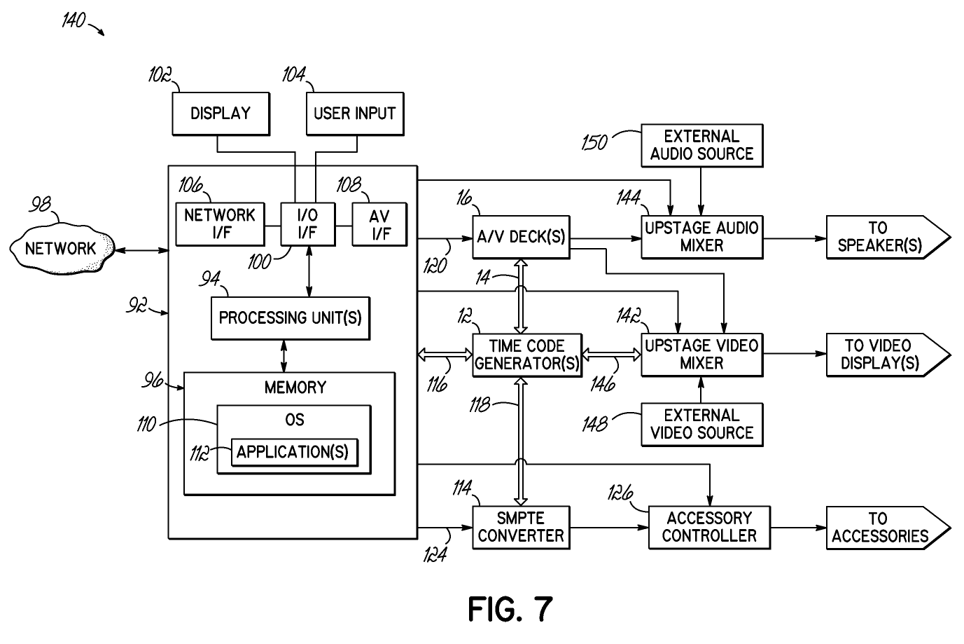

FIG. 7 is a diagrammatic illustration of an alternative embodiment of a control system 140 (“system” 140) to display a multi-component performance on the set 70 of FIG. 5. Similarly to the system 90 of FIG. 6, FIG. 7 illustrates that the system 140 may include the at least one time code generator 12, at least one A/V deck 16, at least one computing system 92 (including the components thereof), at least one SMPTE converter 114, and at least one accessory controller 126. However, the system 140 may further include at least one upstage video mixer 142 and at least one upstage audio mixer 144. The upstage video mixer 142, also commonly referred to as a “video production switcher,” or just “production switcher,” may be configured to combine and/or route a plurality of video components, including at least one video component of an individual performance of the multi-component performance provided by the at least one A/V deck 16. In addition, the upstage video mixer 142 may be configured to provide transitions and/or add special effects to individual video components, among other features. The upstage video mixer 142 may be in communication with the time code generator 12 to receive a time code signal as at 146, and the upstage video mixer 142 may be configured to receive at least one upstage video signal from at least one external video source 148, such as the video camera 86 and/or another external video source. Thus, the output of the upstage video mixer 142 may be connected to at least one of the video displays 72a-e of the set 70 to play at least one video component supplied by the A/V deck 16 and/or the external video source 148.

Similarly to the audio mixer 122 of FIG. 6, the upstage audio mixer 144 of FIG. 7 may be configured to combine, route, and/or change the level, timber, and/or dynamics of a plurality of audio components, including the audio components of the individual performances of a multi-component performance provided by the A/V deck 16. In some embodiments, the upstage audio mixer 144 is a sixteen-channel audio mixer, and in specific embodiments the upstage audio mixer 144 is a Mackie model no. 404-VLZ PRO audio mixer as distributed by LOUD Technologies, Inc., of Woodinville, Wash. In alternative embodiments, the upstage audio mixer 144 may be a digital audio mixer, such as a Yamaha M7CL digital mixing console as distributed by Yamaha Corp. of America, in Buena Park, Calif. The upstage audio mixer 144 may be connected to at least one of the speakers 74a-e and/or 88a, 88b of the set 70 to play at least one audio component of at least one individual performance of a multi-component performance. Additionally, the upstage audio mixer 144 may receive at least one upstage audio signal from at least one external audio source 150, such as the microphone 84 and/or another external audio source. Thus, the upstage audio mixer 144 may be connected to at least one of the speakers 74a-e and/or 88a, 88b of the set 70 to play at least one audio component supplied by the A/V deck 16 and/or the external audio source 150. The SMPTE converter 114 may be configured to convert the SMPTE time code from the time code generator 12 into a MIDI time code and supply that MIDI time code to the upstage audio mixer 144 and/or the accessory controller 126 may be configured to supply a MIDI command to the upstage audio mixer 144.

In some embodiments, some or all of the video displays 72a-e, speakers 74a-e, 88a, 88b, and/or accessories 76, 78, 80 are network-accessible components configured to receive at least a portion of their respective signals, components, and/or commands from the network 98. In those embodiments, at least a portion of the system 90 and/or 140 may be configured at a geographically distant location from the set 70. As such, in the system 90 of FIG. 6, some or all of the signals from the time code generator 12, A/V deck 16, audio mixer 122, and/or accessory controller 126 may be received by the computing system 92 and sent across the network 98 from the computing system 92 directly to the video displays 72a-e, speakers 74a-e, 88a, 88b, and/or accessories 76, 78, 80. Similarly, in the system 140 of FIG. 7, some or all of the signals from the time code generator 12, A/V deck 16, accessory controller 126, upstage video mixer 142, and/or upstage audio mixer 144 may be received by the computing system 92 and sent across the network 98 from the computing system 92 directly to the video displays 72a-e, speakers 74a-e, 88a, 88b, and/or accessories 76, 78, 80.

In other alternative embodiments, at least a portion of the system 90 and/or 140 may be configured at a geographically distant location from the set 70, while the set 70 may include a second computing system (not shown) identical to the computing system 92. As such, in the system 90 of FIG. 6, some or all of the signals from the time code generator 12, A/V deck 16, audio mixer 122, and/or accessory controller 126 may be received by the computing system 92, sent across the network 98 from the computing system 92 to the second computing system, then sent from the second computing system to the respective video displays 72a-e, speakers 74a-e, 88a, 88b, and/or accessories 76, 78, 80 through that second computing system's A/V I/F 108. In the system 140 of FIG. 7, some or all of the signals from the time code generator 12, A/V deck 16, accessory controller 126, upstage video mixer 142, and/or upstage audio mixer 144 may be received by the computing system 92, sent across the network 98 from the computing system 92 to the second computing system, then sent from the second computing system to the respective video displays 72a-e, speakers 74a-e, 88a, 88b, and/or accessories 76, 78, 80.

FIG. 8 is a diagrammatic illustration of an alternative embodiment of a control system 160 (“system” 160) to display a multi-component performance on the set 70 of FIG. 5. Referring to FIG. 8, the primary processing for the system 160 may be performed by at least one computing system 162a, 162b, and in specific embodiments may be performed by a first computing system 162a and a second computing system 162b. Similarly to the computing system 92 of FIG. 6 and FIG. 7, FIG. 8 illustrates that each computing system 162a, 162b includes at least one processing unit 164 communicating with a memory 166. The processing unit 164 may be one or more microprocessors, micro-controllers, field-programmable gate arrays, or ASICs, while memory 166 may include random access memory (RAM), dynamic random access memory (DRAM), static random access memory (SRAM), flash memory, and/or another digital storage medium. As such, memory 166 may be considered to include memory storage physically located elsewhere in each computing system 162a, 162b, e.g., any cache memory in the at least one processing unit 164, as well as any storage capacity used as a virtual memory, e.g., as stored on a mass storage device, a computer, or another controller coupled to each computing system 162a, 162b by way of a network 168. In specific embodiments, each computing system 162a, 162b may be a computer (e.g., a desktop or laptop computer), computer system, controller, server, media server, video server, disk array, or programmable device such as a multi-user computer, a single-user computer, a handheld device, a networked device, or other programmable electronic device. As such, each computing system 162a, 162b may include an I/O I/F 170 in communication with a display 172 and user input device 174 to display information to a user and receive information from the user, respectively. In some embodiments, the user input device 174 may include a keyboard, a mouse, a touchpad, and/or other user interface as is well known in the art. In specific embodiments, the display 172 may be configured with the user input device 174 as a touchscreen (not shown). The I/O I/F 170 may be further in communication with a network interface 176 (illustrated as “Network I/F” 176) that is in turn in communication with the network 168. Moreover, the I/O I/F 170 may be further in communication with an audio/video interface 178 (illustrated as “A/V I/F” 178) that is in turn in communication with at least one component of the system 160. Each computing system 162a, 162b may also include an operating system 180 to run various applications to control at least one component of the set 70 and/or the system 160.

Each computing system 162a, 162b may be configured with at least one application to control at least one component of the set 70 and/or the system 160. Thus, each computing system 162a, 162b may include an audio mixer application 182, a video mixer application 184, an SMPTE converter application 186, an accessory control application 188, and/or a jukebox application 190. The audio mixer application 182, video mixer application 184, SMPTE converter application 186, and/or accessory control application 188 of FIG. 8 may act in a similar manner as the respective hardware based mixers (e.g., audio mixer 122, upstage video mixer 142, and upstage audio mixer 144), SMPTE converter 114, and accessory controller 126 illustrated in FIG. 6 and FIG. 7. The jukebox application 190 may be similar to application 112 illustrated in FIGS. 6 and 7, and may be responsive to a user or user input device 104 to selectively display at least a portion of a multi-component performance, corresponding text, image, video, multi-media presentation, and/or accessory effect. The system 160 may still include at least one time code generator 12 and at least one A/V deck 16.

Each computing system 162a, 162b may also receive an audio signal from an external audio source 150 and/or a video signal from an external video source 148. In this manner, each of the computing systems 162a, 162b may be configured to process the audio and video components of at least one individual performance of the multi-component performance from the at least one A/V deck 16 as well as additional external audio and video signals from the respective external audio source 150 and the external video source 148.

In some embodiments, the computing system 162a (e.g., the “first” computing system 162a) may be configured to receive the audio and video components of at least one individual performance from the A/V deck 16 as at 220 and 222, respectively, and a time code signal 116 from the time code generator 12. The first computing system 162a may mix audio components with the audio mixer application 182, mix video components with the video mixer application 184, convert the SMPTE time code signal 60 from the time code generator 12 to DMX or MIDI with the SMPTE converter application 186, and/or generate commands for the accessories 76, 78, 80 to add synchronized lighting and/or atmospheric effects with the accessory control application 188. However, the first computing system 162a may be at a geographically distant location from the set 70, while the computing system 162b (e.g., the “second” computing system 162b) may be proximate the set 70 and configured to provide at least a portion of the multi-component performance to the set 70.

As such, the first computing system 162a may be configured to receive the audio and video components of at least one individual performance of a multi-component performance from the at least one A/V deck 16 as synchronized by the time code generator 12, mix the individual performances with video signals and/or audio signals from the respective external video and/or audio sources 148, 150, receive the time code signal 116 from the time code generator 12, convert the SMPTE time code 60 to DMX and/or MIDI commands, determine synchronized commands for the accessories 76, 78, 80, and transmit the audio and video components, the mixed audio and video components, the time code signal, the converted DMX and/or MIDI commands, and/or the synchronized accessory commands to the second computing system 162b.

The second computing system 162b, in turn, may be configured to receive the audio and video components, the mixed audio and video components, the received time code, the converted DMX and/or MIDI commands, and/or the synchronized accessory commands and provide the audio and video components and/or mixed audio and mixed video components to the respective speakers 74a-e, 88a, 88b and video displays 72a-e. The second computing system 162b may also be configured to provide the converted DMX and/or MIDI commands and/or the synchronized accessory commands to the accessories 76, 78, 80. Alternatively, the second computing system 162b may be configured to provide the converted DMX and/or MIDI commands and/or the synchronized accessory commands to an accessory controller (not shown in FIG. 8). Moreover, the second computing system 162b may be configured to receive the audio and video components of at least one individual performance and mix that at least one individual performance with video signals and/or audio signals from the respective external video and/or audio sources 148, 150, then provide those video and/or audio signals to the video displays 72a-e and/or speakers 74a-e, 88a, 88b, respectively.

Thus, the system 90, 140, or 160 may be configured to control the video displays 72a-e, speakers 74a-e, 88a, 88b, and accessories 76, 78, 80 of the set 70 to perform a synchronized multi-component performance. Specifically, as illustrated in FIG. 5, the system 90, 140, or 160 may control four video displays 72a-d and four speakers 74a-d to perform the synchronized video and audio components, respectively, of four individual performances of a multi-component performance. The system 90, 140, or 160 may also control the accessories 76, 78, 80 to add synchronized lighting and/or atmospheric effects. The system 90, 140, or 160 may also be configured to display video from the video camera 86 or other external video source 148 and play audio from the microphone 84 or other external audio source 150 on the video display 72e and at least one of the speakers 74e, 88a, 88b, respectively. As such, the system 90, 140, or 160 may be configured to provide a multi-component virtual backup performance for a live vocalist or karaoke. Moreover, the system 90, 140, or 160 may be configured to store a plurality of multi-component performances. In turn, a multi-component performance, which may be stored in one or more A/V deck 16, may be accessed by providing the time code for which a multi-component performance is associated. Additionally, any of the video displays 72a-e may be selectively controlled to display images, text, or other multimedia presentations independently. Similarly, any of the speakers 74a-e may be selectively controlled to play other audio components independently.

Those skilled in the art will recognize that the environments illustrated in FIGS. 5-8 are not intended to limit the present invention. In particular, while FIG. 5 illustrates a set 70 consistent with embodiments of the invention, one having ordinary skill in the art will appreciate that the set 70 may include more or fewer video displays 72a-e, speakers 74a-e, accessories 76, 78, 80, microphones 84, video cameras 86, and/or speakers 88a, 88b than those illustrated. Moreover, the set 70 may have the superstructure 82 omitted. As such, and for example, alternative embodiments of a set consistent with embodiments of the invention may include a computing system controlled kiosk with at least two video displays and at least two speakers configured to selectively playback at least two video and/or audio components of a multi-component performance to produce a desired aesthetic or entertaining performance. In those embodiments, the kiosk may be a karaoke kiosk configured to be interactive with a user to select a multi-component performance for playback and display additional performances and/or presentations. Indeed, those having skill in the art will recognize that other alternative environments may be used without departing from the scope of the invention.

Additionally, one having ordinary skill in the art will recognize that the system 90, 140, or 160 may include more or fewer components without departing from the scope of the invention. For example, any of the systems 90, 140, or 160 may include more or fewer time code generators 12 and A/V decks 16, while the systems 90 and 140 may include more or fewer computing systems 92, SMPTE converters 114, accessory controllers 126, mixers (e.g., audio mixer 122, upstage video mixer 142, and/or upstage audio mixer 144), and/or external sources (e.g., external video source 148 and external audio source 150) than those illustrated. Moreover, one having ordinary skill in the art will recognize that alternative components and configurations other than those specifically disclosed may be used without departing from the scope of the invention. In particular, and referring to system 90 and/or 140, in one alternative embodiment, the A/V deck 16 is in communication with the upstage video mixer 142 such that video components of the multi-component performance and images, text, and/or multimedia presentations from the external video source 148 may be displayed across at least one video display 12a-e. Moreover, in another alternative embodiment, the upstage audio mixer 144 may be omitted and the external audio source 150 may be in communication with the speakers 88a, 88b such that audio components of the multi-component performance may be played across at least one speaker 74a-e and the audio signals from the external audio source 150 may be played across at least one speaker 88a, 88b. Thus, for example, the video component of an individual performance of a multi-component performance may be migrated across the video displays 72a-e during the multi-component performance, video components of individual performances may be faded, swiped, or otherwise manipulated between multi-component performances, and/or other images, text, and/or videos may be played on the video displays 72a-e before, during, and/or after multi-component performances. As such, other alternative hardware environments and other alternative components may be used without departing from the scope of the invention

### Performing Multi-Component Performances

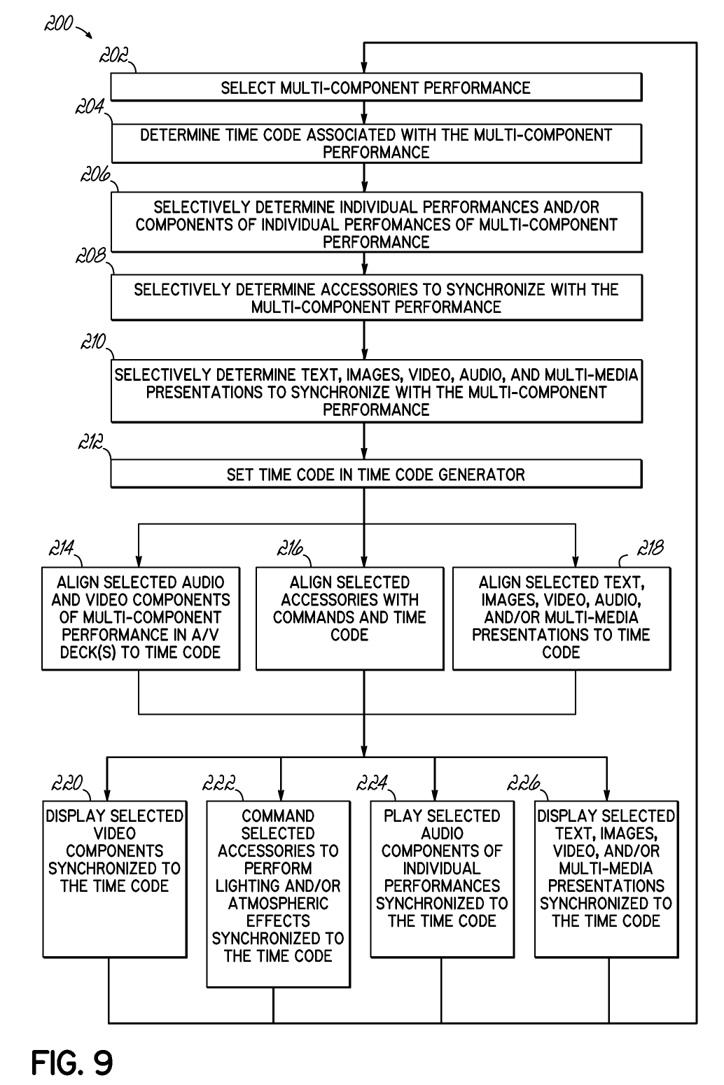

FIG. 9 is a flowchart 200 illustrating a process for at least one of the systems of FIGS. 6-8 to display a multi-component performance on the set of FIG. 5. The process begins with the selection of a multi-component performance (block 202). In some embodiments, the selection of the multi-component performance may be made by a user of the system. For example, the user may be presented with a list of multi-component performances on the system and be instructed to select from that list. When the user selects a multi-component performance, the system may determine the time code associated with that multi-component performance (block 204). The user, or the system, may then selectively determine the audio and/or video components, and/or the individual performances, of that multi-component performance they wish to display (block 206). For example, the user may wish to display fewer components and/or performances of the multi-component performance than are available, and as such the user may selectively determine which audio and video components and/or individual performances to display. Also for example, the set may be configured with fewer speakers and/or video displays than there are audio and/or video components of the multi-component performance, and as such the system may selectively determine which audio and/or video components of the multi-component performance to display.

In addition to selectively determining the audio components, the video components, and/or the individual performances of the multi-component performance to display, the user and/or the system may selectively determine the accessories to synchronize with the multi-component performance to provide lighting and/or atmospheric effects (block 208). In some embodiments, the user selects the accessories to include with the multi-component performance, while in other embodiments or the system automatically determines which accessories are included in the set, and/or which accessories are associated with synchronized commands for that multi-component performance, and includes commands those accessories during the multi-component performance. The user and/or the system may also selectively determine text, images, video components, audio components, and multi-media presentations to synchronize with the multi-component performance (block 210). For example, the user may associate images, scrolling text, advertisements, or other multi-media presentations with the multi-component performance, or the system may do so automatically. The system may then set the time code determined to be associated with the multi-component performance in the time code generator (block 212). In specific embodiments, a computing system in communication with a time code generator that has determined the time code associated with the multi-component performance may selectively control the time code generator to set the time code of the time code generator to that time code associated with the multi-component performance.

After setting the time code associated with the multi-component performance in the time code generator, the selected audio and video components of the multi-component performance in the A/V decks of the system may be aligned to the time code (block 214), the commands (e.g., DMX commands, MIDI commands) associated with accessories and/or mixers or other components may be aligned to the time code (block 216), and the selected text, images, video components, audio components, and/or multi-media presentations in the A/V decks, computing systems, external video sources, and/or external audio sources may be aligned to the time code (block 218). As such, the system may be dependent on the time code provided by the time code generator and display selected video components on selected video displays synchronized to the time code (block 220), command selected accessories to perform lighting and/or atmospheric effects synchronized to the time code (block 222), play selected audio components on selected speakers synchronized to the time code (block 224), and/or display selected text, images, video components, audio components, and/or multi-media presentations on selected video displays and/or speakers synchronized to the time code (block 226) to perform the multi-component performance. After performance of the multi-component performance has completed, the system may wait for the user to select a multi-component performance to perform, or the system may perform the next sequential multi-component performance.

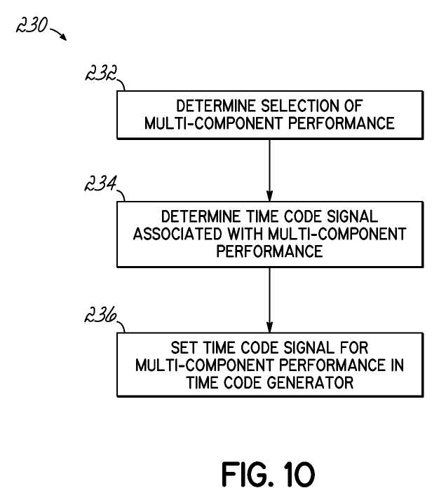

Each of the control systems to display the multi-component performance may be configured with program code to determine the time code associated with a particular multi-component performance and act in conjunction with the flowchart 190 of FIG. 9 to perform that multi-component performance. FIG. 10 is a flowchart 230 illustrating a process for program code that may be executed by one of the systems of FIGS. 6-8 to select a multi-component performance consistent with embodiments of the invention. In some embodiments, the program code may be the application of the systems of FIG. 6 and FIG. 7, or the jukebox application of the system of FIG. 8. The program code may determine the selection of a multi-component performance by monitoring the user input device and/or receiving the selection from across a network (block 232). To queue the multi-component performance, the program code may then determine the time code signal associated with the selected multi-component performance (block 234). In some embodiments, the program code may have a list of the noted start and end times of the multi-component performances (e.g., as disclosed in FIGS. 3 and 4). Thus, the program code may determine that a selected multi-component performance is associated with a specific time code signal (e.g., the user may select “Brown-Eyed Girl” and the program code may determine the time code, which may be “01:00:00:00,” from the list of the start times of the multi-component performances stored on the A/V decks and/or the system itself). Once the program code has determined the time code signal for a multi-component performance, the program code may set the time code signal for the multi-component performance in the time code generator of the system (block 236), thus allowing the alignment of selected audio and video components, selected accessories and commands thereof, and selected text, images, video, audio, and/or multi-media presentations.

Accordingly, the invention provides for improved apparatuses and methods to record and then display components of a performance. A time code signal may be linked or coupled to recorded video and audio signals for each performance or presenter and their individual performances of a performance may be recorded. These signals and individual performances may be selectively displayed and replayed on individual display devices separately from, but coordinated in time with, the display of other recorded video and audio components, thereby reproducing a joint performance selectively and with the full fidelity and effect as if in real time. The aesthetic and entertainment values of the invention are both widely varied and enormous. For example, individual video and audio components of individual performances of a coordinated performance are separately recorded, aligned with a common time code signal, and selectively displayed to produce a desired aesthetic, entertaining performance of any or all of the components in video, audio, or combinations thereof. At least a portion of the individual video and audio components of the individual performances may be then synchronized and selectively displayed along with additional performances and/or presentations, such as live performances, images, text, video, multimedia presentations, or combinations thereof. Moreover, these individual video and audio components may be further synchronized with effects, such as lighting and/or atmospheric effects from spotlights, fog machines, laser projectors, and other accessories.

Therefore, embodiments of the invention may be used to synchronize and selectively display video and/or audio components of at least a portion of individual performances of a coordinated performance and act as a virtual band from which coordinated performances may be selectively chosen, act as a virtual backup band for live vocalists, selectively display additional text and act as a virtual backup band for karaoke, selectively display commercial messages with the coordinated performance, and/or integrate additional effects, images, text, video, multimedia presentations, or combinations thereof into a coordinated performance. Thus, embodiments of the invention may be configured to create the entertaining and aesthetic experience of a live performance without the issues associated with live performances.

Moreover, embodiments of the invention may be used to selectively display video and/or audio components of a least a portion of individual performances of a coordinated performance that is not a musical performance. For example, embodiments of the invention may be used to selectively display video and/or audio components of a presentation by one or more persons, a dramatic performance by one or more persons, and/or embodiments of the invention may be used to simultaneously tape a coordinated performance at a first location and display that coordinated performance live at a second location. Thus, embodiments of the invention may be used to synchronize and selectively display at least a portion of a recorded coordinated performance, display at least a portion of a live coordinated performance, interact with live performances, incorporate branding with coordinated performances, and/or display at least a portion of a dramatic performance or presentation.

Embodiments consistent with the invention may be referred to as a PLASMA PEOPLE system. Moreover, embodiments consistent with the invention may be consistent with a PLASMA PEOPLE system as distributed by The Pebble Creek Group of Fort Thomas, Ky.

While the invention has been described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described herein may be identified based upon the application or software component within which it is implemented in a specific embodiment of the invention. However, it should be appreciated that any particular program nomenclature is used merely for convenience, and thus embodiments of the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

While embodiments of the present invention have been illustrated by a description of the various embodiments and the examples, and while these embodiments have been described in considerable detail, it is not the intention of the applicants to restrict or in any way limit the scope of the appended claims to such detail. Moreover, the invention is not limited to use with musical performance, but can advantageously be used with educational, dramatic, and promotional presentations, for example. Additional advantages and modifications will readily appear to those skilled in the art. Thus, the invention in its broader aspects is therefore not limited to the specific details, representative apparatus and method, and illustrative example shown and described. In particular, any of the blocks of the above flowcharts may be deleted, augmented, made to be simultaneous with another, combined, or be otherwise altered in accordance with the principles of the present invention. Accordingly, departures may be made from such details without departing from the spirit or scope of applicant's claims appended hereto.

What is claimed is:

1. An apparatus for displaying components of a performance, the apparatus comprising:
a computer;
a time code generator in communication with the computer and selectively controlled by the computer to generate a time code signal;
a digital video recorder having at least one output channel, each output channel having respective video and audio outputs, the digital video recorder in operable communication with the time code generator, the digital video recorder responsive to the time code signal to output at least a portion of a first video component and a corresponding first audio component of the performance synchronized to the time code signal to a respective first video display and first audio amplifier.

2. The apparatus of claim 1, further comprising:
at least one accessory in communication with the computer and selectively controlled by the computer to produce at least one of a lighting effect or an atmospheric effect based on the time code signal.

3. The apparatus of claim 2, wherein the at least one accessory is at least one accessory selected from the group consisting of a spotlight, a fog machine, a laser projector, and combinations thereof.

4. The apparatus of claim 1, wherein the digital video recorder is a first digital video recorder, the system further comprising:
a second digital video recorder having at least one output channel, each output channel having respective video and audio outputs, the second digital video recorder in communication with the time code generator, the second digital video recorder responsive to the time code signal to output at least one of text, an image, a video, or a multi-media presentation synchronized to the performance on a third video display.

5. The apparatus of claim 1, further comprising:
a microphone having an audio output; and
at least one audio mixer in communication with the digital video recorder and the microphone, the audio mixer operable to receive the first audio component from the digital video recorder, the audio mixer operable to receive the audio output from the microphone, the audio mixer further operable to play the first audio component of the performance on the first audio amplifier and play the audio output of the microphone on a second audio amplifier.

6. The apparatus of claim 1, further comprising:
a video camera having a video output; and
at least one video mixer in communication with the digital video recorder and the video camera, the video mixer operable to receive the first video component from the digital video recorder, the video mixer operable to receive the video output from the video camera, and the video mixer further operable to display the first video component of the performance on the first video display and display the video output of the video camera on a second video display.

7. The apparatus of claim 1, further comprising:
at least one audio mixer in communication with the digital video recorder and an external audio source, the audio mixer operable to receive the first audio component from the digital video recorder, the audio mixer operable to receive a second audio component from the external audio source, the audio mixer further operable to play the first audio component of the performance on the first audio amplifier and play the second audio component on a second audio amplifier.

8. The apparatus of claim 1, further comprising:
at least one video mixer in communication with the digital video recorder and an external video source, the video mixer operable to receive the first video component from the digital video recorder, the video mixer operable to receive a second video component from the external video source, the video mixer further operable to display the first video component of the performance on the first video display and display the second video component on a second video display.

9. The apparatus of claim 8, wherein the external video source is an external video source selected from the group consisting of a video camera, a second digital video recorder, the computer, a second computer, or combinations thereof.

10. The apparatus of claim 1, further comprising:
at least one a microphone in communication with the digital video recorder; and
at least one video camera in communication with the digital video recorder,
wherein the digital video recorder is configured to record the first audio component of the performance with the at least one microphone and record the first video component of the performance with the at least one video camera, and wherein the system is further configured to associate the first audio component and the first video component with the time code signal from the time code generator at the time of recording.

11. The apparatus of claim 1, wherein the digital video recorder is further configured with at least two output channels, the digital video recorder further responsive to the time code signal to output at least a portion of a second video component and a corresponding second audio component of the performance synchronized to the time code signal to a respective second video display and second audio amplifier.

12. An apparatus for recording and displaying components of a performance, the performance of the type that includes a plurality of individual performances, the apparatus comprising:
a plurality of microphones, each microphone configured to record a respective audio component of an individual performance;
a plurality of video cameras, each video camera configured to record a respective video component of an individual performance;
at least one time code generator to generate a time code signal; and
a plurality of digital video recorders, each digital video recorder having at least one input channel, each digital video recorder having respective video and audio inputs and respective video and audio outputs, each digital video recorder in operable communication with the time code generator, a first digital video recorder among the plurality of digital video recorders in operable communication with a first microphone among the plurality of microphones and configured to record a first audio component of a first individual performance, the first digital video recorder in operable communication with a second microphone among the plurality of microphones and configured to record a second audio component of a second individual performance, the first digital video recorder in operable communication with a first video camera among the plurality of video cameras and configured to record a first video component of the first individual performance, the first digital video recorder in operable communication with a second video camera among the plurality of video cameras and configured to record a second video component of the second individual performance, the first digital video recorder further configured to associate the first and second audio components and the first and second video components with the time code signal as the first and second audio components and the first and second video components are recorded, wherein the first digital video recorder is responsive to the time code signal to output at least a portion of the first video component and the corresponding first audio component of the performance synchronized to the time code signal to a respective first video display and first audio amplifier, and wherein the first digital video recorder is responsive to the time code signal to output at least a portion of the second video component and the corresponding second audio component of the performance synchronized to the time code signal to a respective second video display and second audio amplifier.

13. An apparatus for displaying components of a performance, the system comprising:
a time code generator for generating a time code signal;
a digital video recorder having at least one output channel, each output channel having respective video and audio outputs, the digital video recorder in communication with the time code generator, the digital video recorder responsive to the time code signal to output at least a portion of a first video component and a corresponding first audio component of the performance synchronized to the time code signal on a first output channel; and
a first computer in communication with the time code generator and the digital video recorder, the first computer configured to selectively control the time code generator to generate the time code signal, the first computer configured to receive the synchronized video and audio components of the performance, the first computer further configured to provide the synchronized video and audio components of the performance to a second computer for displaying the first video component on a respective video display and for playing the first audio component on a respective audio amplifier.

14. The apparatus of claim 13, wherein the digital video recorder is further configured with at least two output channels, wherein the digital video recorder is further responsive to the time code signal to output at least a portion of a second video component and a corresponding second audio component of the performance synchronized to the time code signal on a second output channel, and wherein the second computer is further configured to provide the synchronized video and audio components of the performance to the second computer for displaying the second video component on a respective second video display and for playing the second audio component on a respective second audio amplifier.

15. A method for displaying a performance with an apparatus, the method comprising:
aligning recorded components of the performance with a time code signal; and
selectively displaying at least a portion of a first video component of the performance and selectively playing at least a portion of a first audio component of the performance corresponding to the first video component based on the time code signal.

16. The method of claim 15, further comprising:
simultaneously displaying at least a portion of a second video component and selectively playing at least a portion of a second audio component of the performance corresponding to the second video component based on the time code signal.

17. The method of claim 15, further comprising:
aligning commands for at least one accessory with the time code signal; and
selectively controlling the at least one accessory to produce at least one of a lighting effect or an atmospheric effect based on the time code signal.

18. The method of claim 15, further comprising:
aligning at least one of text, an image, a video, or a multi-media presentation with the time code signal; and
displaying the at least one of a selection of text, an image, a video, or a multi-media presentation based on the time code signal.

19. The method of claim 18, further comprising:
selectively amplifying at least one audio output of a microphone of a live performer.

20. The method of claim 15, further comprising:
separately recording the audio and video components of a plurality of individual performers of the performance; and
associating each separate recording of the audio and video components of the plurality of individual performers with the time code signal.

21. The method of claim 20, wherein selectively displaying the at least a portion of the first video component of the performance and selectively playing the at least a portion of the first audio component of the performance corresponding to the first video component based on the time code signal further comprises:
selectively controlling the display of the first video component and the playing of the first audio component corresponding to the first video component to cease the display of at least one of the first video component and the first audio component.

22. The method of claim 15, further comprising:
selecting a performance to display; and
determining a time code signal associated with that performance and with which to align the recorded components of the performance.

23. A method for recording and displaying a performance with an apparatus, the method comprising:
recording a plurality of individual performances of the performance, each individual performance having a video component and an audio component;
associating each of the individual performances with a time code signal at the time of recording, including associating each video component and each audio component of each individual performance with the time code signal at the time of recording; and
selectively displaying at least a portion of the video components and the audio components of at least two individual performances, including coordinating the video components and audio components of the at least two individual performances with the time code signal.
